(19) United States
(12) Patent Application Publication
(10) Pub. No.: US 2017/0175799 A1
(43) Pub. Date: Jun. 22, 2017

(54) DEVICE FOR SECURING A PACKING NUT ON A FRACKING PUMP

(71) Applicant: Jayson Arnold, Buda, TX (US)

(72) Inventor: Jayson Arnold, Buda, TX (US)

(21) Appl. No.: 15/382,221

(22) Filed: Dec. 16, 2016

Related U.S. Application Data
(60) Provisional application No. 62/268,199, filed on Dec. 16, 2015.

(51) Int. Cl. F16B 41/00; F04B 53/02; F04B 19/22

(52) U.S. Cl. CPC F16B 41/007; F04B 19/22; F04B 53/02; E21B 43/26

(57) ABSTRACT

A locking device for securing a packing nut on a fracking pump is disclosed. The locking device includes a clamp secured to the packing nut and a stop arm that rests on a fixed rod (e.g., a stay rod) of the fracking pump. With the clamp secured to the packing nut and the stop arm contacting and resting on the stay rod, the packing nut is inhibited from loosening or disengaging from a cylinder block of the fracking pump.

### PRIORITY CLAIM

This patent claims priority to U.S. Provisional Patent Application No. 62/268,199 to Arnold, entitled “DEVICE FOR SECURING A PACKING NUT ON A FRACKING PUMP”, filed Dec. 16, 2015, which is incorporated by reference in its entirety as if fully set forth herein.

### BACKGROUND

1. Field of the Invention

The present invention relates in general to fracking pumps. More particularly, the invention relates to devices for retaining packing nuts from loosening or disengaging on fracking pumps.

2. Description of Related Art

When fracking pumps (e.g., reciprocating pumps) are operated at high pressures and/or high power for extended lengths of time, nuts and/or bolts on the fracking pumps may loosen or possibly disengage (e.g., back out) over time. The potential for loosening of nuts and/or bolts is especially symptomatic for large nuts such as packing nuts. Loosening of packing nuts may result in slop in packing, possibly leading to failed packing and/or a washed out packing bore. To avoid packing nuts from becoming too loose, often a technician or other personnel manually checks and tightens packing nuts as needed during pumping. Manually checking, however, may be time consuming and/or dangerous to the personnel as they are working in or near active equipment. Thus, there is a need for devices and/or mechanisms to ensure that packing nuts are inhibited from loosening during operation of the fracking pump.

### SUMMARY

In certain embodiments, a locking device includes a ring-shaped clamp with two clamp jaws attached to a hinge. The clamp jaws may include clamp ends configured to meet and close the clamp around a packing nut for a fracking pump (e.g., a high pressure, high volume reciprocating pump). A fastener may be configured to secure the clamp ends around the packing nut. A stop arm may be attached to at least one clamp end. The stop arm may be configured to contact a fixed rod in the fracking pump to inhibit rotation of the ring-shaped clamp. In some embodiments, a locking fastener is radially inserted through one of the clamp jaws. The locking fastener may be configured to tighten the ring-shaped clamp onto the packing nut. In some embodiments, the locking fastener includes a set screw threaded through a threaded opening in one of the clamp jaws.

In some embodiments, the clamp jaws are c-shaped clamp jaws configured to form a ring-shape when closed. In some embodiments, each clamp end includes a boss. The boss may be configured to come into contact when the clamp ends are in contact. The fastener may secure the boss together to secure the clamp ends around the packing nut. The fastener may be a threaded fastener with a first boss having an opening to allow the threaded fastener to pass through the first boss with a head of the threaded fastener resting on a surface of the first boss. A second boss may include a threaded opening having threads that engage threads on the threaded fastener to secure the threaded fastener to the second boss. The threaded fastener may be tightened using the engaged threads to secure the clamp ends around the packing nut.

In certain embodiments, the locking device inhibits the packing nut from moving or rotating during use. In some embodiments, the stop arm is configured to contact a stay rod in the fracking pump to inhibit rotation of the ring-shaped clamp.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a side-view representation of an embodiment of a locking device.

FIG. 2 depicts a perspective representation of an embodiment of a clamp fit snugly onto a packing nut.

FIG. 3 depicts a perspective representation of an embodiment of a clamp fit snugly onto a packing nut and a stop arm contacting and resting on a stay rod.

FIG. 4 depicts one additional perspective representation of an embodiment of a clamp fit onto a packing nut.

FIG. 5 depicts another perspective representation of an embodiment of a clamp fit onto a packing nut.

FIG. 6 depicts yet another perspective representation of an embodiment of a clamp fit onto a packing nut.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

In the context of this patent, the term “coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

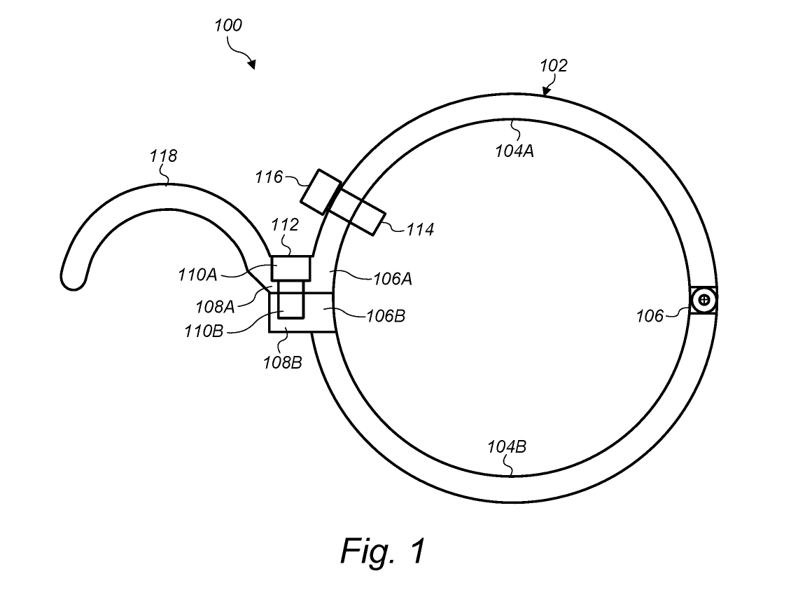

FIG. 1 depicts a side-view representation of an embodiment of locking device 100. Locking device 100 may be used to secure a packing nut on a fracking (frac) pump and inhibit the packing nut from loosening or disengaging (backing out) from a fluid end of the fracking pump (e.g., the packing nut is kept tight in a cylinder block in the fluid end of the fracking pump). In certain embodiments, locking device 100 is made from high strength, high temperature resistant, and corrosion resistant material. For example, locking device 100 may be made of aluminum and/or steel. In one embodiment, locking device 100 is made of 6061 aluminum. Locking device 100 may have a thickness on the order of a width that a packing nut extends from a fracking pump. For example, locking device 100 may have a thickness of about ¾″.

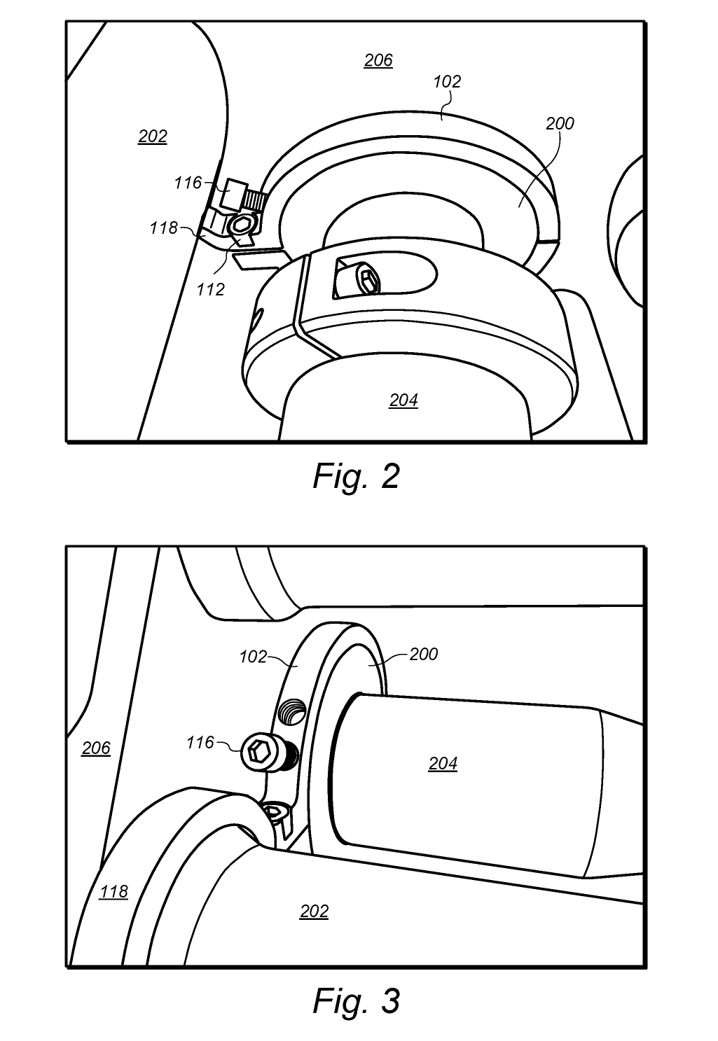

In certain embodiments, locking device 100 includes ring-shaped clamp 102. Clamp 102 may include two clamp jaws 104A, 104B attached to hinge 106. Clamp jaws 104A, 104B may rotate about hinge 106 to open and close the clamp. Ends 106A, 106B of clamp jaws 104A, 104B may contact each other when clamp 102 is closed, as shown in FIG. 1 (e.g., the faces of the clamp ends are in contact with each other). When closed, clamp jaws 104A, 104B may form clamp 102 into a ring with a size and shape suited to be placed around a packing nut of a fracking pump (e.g., the clamp jaws are c-shaped clamp jaws that form a ring shape when closed). In certain embodiments, clamp 102 is formed into a ring that fits snugly onto the packing nut. FIG. 2 depicts a perspective representation of an embodiment of clamp 102 fit snugly onto packing nut 200.

In certain embodiments, as shown in FIG. 1, bosses 108A, 108B extend from clamp ends 106A, 106B. Bosses 108A, 108B may include openings 110A, 110B to allow fastener 112 to secure clamp ends 106A, 106B together. Fastener 112 may be, for example, a set screw or other bolt with a head attached to threads. Opening 110A may have a recessed surface or other surface that provides a stop for the head of fastener 112 (e.g., the head of the fastener presses against the surface when the fastener is inserted through the opening). Opening 110B may include threads or other devices to engage the threads on fastener 112. In another embodiment, opening 110B may pass through boss 108B and a nut or other device may engage the threads on fastener 112 to secure clamp ends 106A, 106B together.

Engagement of the threads on fastener 112 and the threads in opening 110B may allow the fastener to pull boss 108B towards boss 108A and secure the bosses together. Securing boss 108A and boss 108B together tightens and secures clamp ends 106A and 106B together with clamp 102 in the closed position. Thus, clamp 102 may be tightened and secured onto packing nut 200 using fastener 112, as shown in FIG. 2.

In some embodiments, as shown in FIG. 1, clamp jaw 104A includes opening 114 radially through the clamp jaw (e.g., directed towards a center of clamp 102 when the clamp is closed). Locking fastener 116 may be inserted through opening 114. Locking fastener 116 may be used to secure clamp 102 to packing nut 200, as shown in FIG. 2. Opening 114 and locking fastener 116 may include threads that engage to secure the locking fastener against packing nut 200. For example, locking fastener 116 may be a set screw that engages an outer surface of packing nut 200 to secure clamp 102 against the packing nut.

In certain embodiments, locking device 100 includes stop arm 118 attached to, or extending from, boss 108A, as shown in FIG. 1. In some embodiments, stop arm 118 is formed as part of locking device 100 (e.g., formed from a single piece of material). Stop arm 118 may be a curved arm or other shaped arm configured to contact and rest on a fixed rod or bolt on the fracking pump (e.g., a stay rod of the fracking pump). Stop arm 118 may be configured to contact and rest on any other fixed object on the fracking pump. For example, stop arm 118 may contact and rest on a fixed protrusion on the fracking pump or a protrusion affixed to the fracking pump.

FIG. 3 depicts a perspective representation of an embodiment of clamp 102 fit snugly onto packing nut 200 and stop arm 118 contacting and resting on stay rod 202. In certain embodiments, as shown in FIG. 3, stop arm 118 has a curvature that substantially matches the curvature of stay rod 202. Thus, stop arm 118 may rest snugly (and/or securely) on stay rod 202 such that vibration of the fracking pump does not disengage the stop arm from the stay rod.

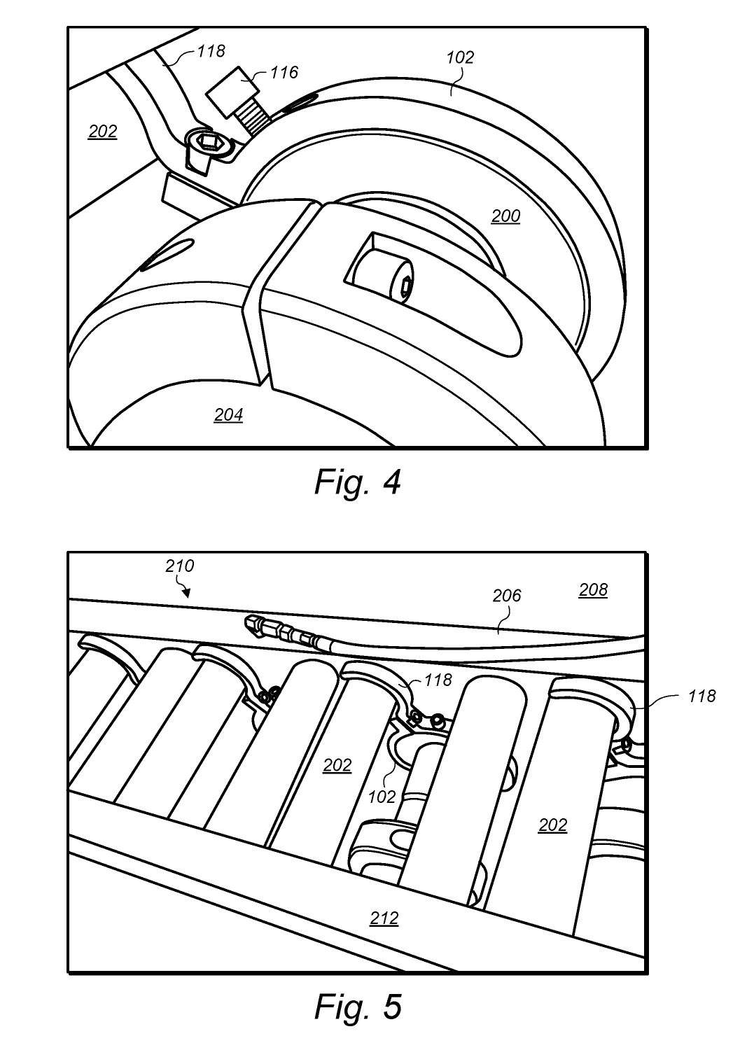

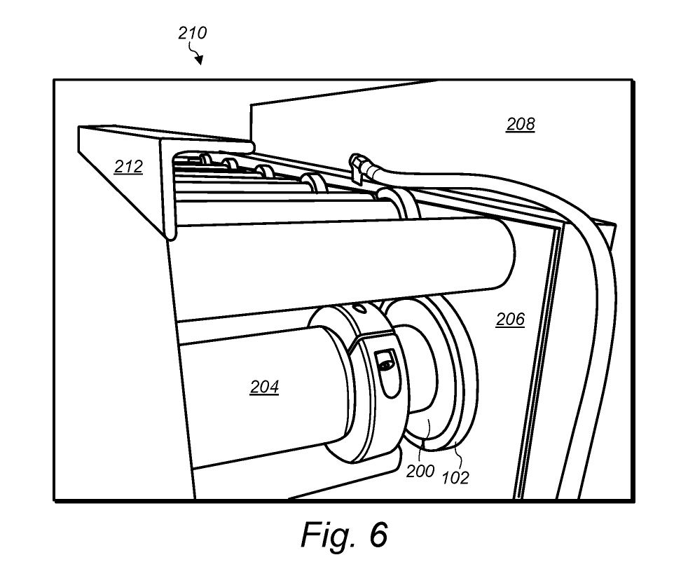

FIGS. 4, 5, and 6 depict additional perspective representation of an embodiment of clamp 102 fit onto packing nut 200. As shown in FIGS. 2-6, packing nut 200 is used to attach rod 204 to cylinder block 206. Cylinder block 206 may be located on fluid end 208 of fracking pump 210, as shown in FIGS. 5 and 6. Rod 204 may connect to power end 212 of fracking pump 210. Stay rod 202 may be a fixed bolt or rod (e.g., a non-moving rod) that attaches power end 212 to fluid end 208 in fracking pump 210.

As shown in FIGS. 2-6, clamp 102 may be tightened and secured onto packing nut 200 using fastener 112 and/or fastener 116. Additionally, stop arm 118 may contact and rest on stay rod 202 (or another fixed object in fracking pump 210). In certain embodiments, the combination of clamp 102 being tightened and secured onto packing nut 200 and stop arm 118 resting on stay rod 202 inhibits movement (e.g., rotation) of clamp 102 in a direction (e.g., in a counterclockwise direction) that may loosen or disengage packing nut 200 from cylinder block 206. Thus, locking device 100 inhibits packing nut 200 from backing out (disengaging) or loosening during use. Packing nut 200 may be removed by loosening clamp 102 and removing the clamp from around the packing nut to allow access to the packing nut.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a fastener” includes a combination of two or more fasteners and reference to “a material” includes mixtures of materials.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A locking device, comprising:
a ring-shaped clamp comprising two clamp jaws attached to a hinge, wherein the clamp jaws comprise clamp ends configured to meet and close the clamp around a packing nut for a fracking pump;
a fastener configured to secure the clamp ends to each other; and
a stop arm extending from at least one clamp end, wherein the stop arm is configured to contact a fixed object in the fracking pump to inhibit rotation of the ring-shaped clamp in a direction that disengages the packing nut.

2. The device of claim 1, further comprising a locking fastener radially inserted through one of the clamp jaws, wherein the locking fastener is configured to secure the ring-shaped clamp onto the packing nut.

3. The device of claim 2, wherein the locking fastener comprises a set screw threaded through a threaded opening in one of the clamp jaws.

4. The device of claim 1, wherein the clamp jaws are c-shaped clamp jaws configured to form a ring-shape when the clamp ends are secured to each other.

5. The device of claim 1, wherein each clamp end comprises a boss, the boss being configured to come into contact when the clamp ends are in contact, and wherein the fastener secures the bosses together to secure the clamp ends to each other.

6. The device of claim 5, wherein the fastener comprises a threaded fastener, wherein a first boss comprises an opening to allow the threaded fastener to pass through the first boss with a head of the threaded fastener resting on a surface of the first boss, and wherein a second boss comprises a threaded opening comprising threads that engage threads on the threaded fastener to secure the threaded fastener to the second boss.

7. The device of claim 6, wherein the threaded fastener is tightened using the engaged threads to secure the clamp ends to each other.

8. The device of claim 1, wherein the locking device inhibits the packing nut from rotating in the direction that disengages the packing nut when the stop arm contacts the fixed object in the fracking pump.

9. The device of claim 1, wherein the fixed object comprises a fixed rod in the fracking pump, and wherein the stop arm has a curvature that substantially matches a curvature of the fixed rod such that when the stop arm contacts the fixed rod, the stop arm inhibits rotation of the ring-shaped clamp in the direction that disengages the packing nut.

10. A method for securing a packing nut on a fracking pump, comprising:
closing a ring-shaped clamp around the packing nut on the fracking pump, the ring-shaped clamp comprising two clamp jaws attached to a hinge, wherein the clamp jaws comprise clamp ends that meet and close the clamp around the packing nut; and
securing the clamp ends to each other using a fastener;
wherein the clamp comprises a stop arm extending from at least one clamp end, and wherein the stop arm contacts a fixed object in the fracking pump to inhibit rotation of the ring-shaped clamp in a direction that disengages the packing nut.

11. The method of claim 10, further comprising radially inserting a locking fastener through one of the clamp jaws, wherein the locking fastener secures the ring-shaped clamp onto the packing nut.

12. The method of claim 11, wherein the locking fastener is threaded through a threaded opening in one of the clamp jaws.

13. The method of claim 10, wherein the clamp jaws are c-shaped clamp jaws that form a ring-shape when the clamp ends are secured to each other.

14. The method of claim 10, wherein each clamp end comprises a boss, wherein securing the clamp ends to each other comprises contacting the bosses to each other and securing the bosses to each other using the fastener.

15. The method of claim 14, wherein the fastener passes through an opening in the first boss with a head of the fastener resting on a surface of the first boss, and wherein the fastener engages threads in a threaded opening in a second boss to secure the fastener to the second boss.

16. The method of claim 10, wherein the packing nut is inhibited from rotating in the direction that disengages the packing nut when the stop arm contacts the fixed object in the fracking pump.

17. The method of claim 10, wherein the fixed object comprises a fixed rod in the fracking pump, and wherein the stop arm has a curvature that substantially matches a curvature of the fixed rod such that when the stop arm contacts the fixed rod, the stop arm inhibits rotation of the ring-shaped clamp in the direction that disengages the packing nut.
